(19) United States
(12) Patent Application Publication
(10) Pub. No.: US 2022/0076181 A1
(43) Pub. Date: Mar. 10, 2022

(54) ESTIMATION METHOD, ESTIMATION DEVICE, AND ESTIMATION PROGRAM

(71) Applicant: NIPPON TELEGRAPH AND TELEPHONE CORPORATION, Tokyo (JP)

(72) Inventors: Miho IKEDA, Musashino-shi, Tokyo (JP); Tsuneko KURA, Musashino-shi, Tokyo (JP); Koji KISHI, Musashino-shi, Tokyo (JP); Hiroyuki UEKAWA, Musashino-shi, Tokyo (JP); Satoshi TAKAHASHI, Musashino-shi, Tokyo (JP)

(73) Assignee: NIPPON TELEGRAPH AND TELEPHONE CORPORATION, Tokyo (JP)

(21) Appl. No.: 17/414,319

(22) PCT Filed: Jan. 15, 2020
(86) PCT No.: PCT/JP2020/001042

§ 371 Date: Jun. 16, 2021

(30) Foreign Application Priority Data
Jan. 29, 2019 (JP) 2019-013229

(51) Int. Cl. G06Q 10/06

(52) U.S. Cl. CPC G06Q 10/06315; G06Q 10/06375; G06Q 10/06316

(57) ABSTRACT

A deriving unit (15a) derives correspondences between businesses and any one or a plurality of work assist systems, work functions, programs, software, and setting information of the software, a calculation unit (15b) calculates any one or a plurality of importances of the work assist systems, the work functions, the programs, the software, and the setting information of the software using predetermined importances of the businesses, an analyzing unit (15c) analyzes importances based on utilization trends using utilization trends of work assist systems (Ns) in a predetermined period of time and each of the calculated importances, and a computing unit (15d) computes effects on the businesses using failure information of the work assist systems (Ns), the calculated importances and each of the analyzed importances based on the utilization trends.

### TECHNICAL FIELD

The present invention relates to an estimation method, an estimation apparatus, and an estimation program.

### BACKGROUND ART

Organizations such as companies and government offices use one or a plurality of IT systems for efficient work. When an incident of an IT system failure due to a program bug, machine breakdown, or a cyber attack occurs, a work using this IT system has to be delayed or stopped, and the entire business is affected. To prepare for such a situation, making a business continuity plan of analyzing and evaluating effects in a case in which incidents occur and preparing measures for preventing such incidents and measures for handling occurrence of incidents has been recommended (see Non Patent Literature 1 and 2).

In the related art, making a business continuity plan is performed in a procedure in which a basic policy is made, effects on business and risks are analyzed and evaluated, and business continuity strategies and measures are examined. The analysis of the effects on business is performed in a procedure in which effects of interruption of the business are evaluated, important work to be continued and recovered with priority is chosen in consideration of the result of the evaluation, target recovery times and target recovery levels are set, and important elements that are essential to perform each important task are recognized to extract bottlenecks.

Also, the analysis of risks is performed in a procedure in which occurring situations that may cause interruption of the business are listed, probabilities of occurrence of the situations and effects in a case in which the situations occur are evaluated, occurring situations to be addressed with priority are chosen, damage to important work chosen through the analysis of the effects on the business due to the occurring situations is examined, and target recovery times and target recovery levels are estimated.

In order to efficiently make a measure for preventing an incident or a measure for handling occurrence of an incident in terms of business continuity in accordance with such procedures, it is necessary to precisely analyze the effects on the business and the risks.

### CITATION LIST

### Non Patent Literature

[Non Patent Literature 1] “Business Continuity Guidelines—Strategies and Responses for Surviving Critical Incidents,” [online], August, 2013, Cabinet Office, Government of Japan, [Retrieved Dec. 20, 2018], Internet <URL: http://www.bousai.go.jp/kyoiku/kigyou/pdf/guideline03.pdf>
[Non Patent Literature 2] “NIST Special Publication 800-34 Rev. 1 Contingency Planning Guide for Federal Information Systems,” [online] May 2010, National Institute of Standards and Technology [Retrieved Dec. 20, 2018], Internet <URL: https://nvlpubs.nist.gov/nistpubs/Legacy/SP/nistspecialpublication800-34r1.pdf>

### SUMMARY OF THE INVENTION

### Technical Problem

However, it may be difficult to efficiently analyze and precisely evaluate effects on a business and risks according to the techniques in the related art. For example, information used to analyze the effects on the business changes with elapse of time due to changes in configurations of the business caused by expansion or contraction of the business, withdrawal from the business, or launching of a new business, replacement of IT systems used for a work in the business, and the like in reality. It is thus desirable to reanalyze the effects on the business and the risks in a case in which the information to be used to analyze the effects on the business and the risks changes to such an extent that a business continuity plan made on the basis of the result of analysis changes.

However, analyzing and evaluating the effects on the business and the risks using the latest information and amending the business continuity plan every time the analysis and the evaluation are performed are operations that require significant effort. Therefore, in a case in which an incident that is overevaluated or underevaluated and is not appropriately analyzed and evaluated in accordance with a current business continuity plan has occurred before the business continuity plan is revised, there is a concern that an appropriate measure for handling the incident will not be performed in accordance with the business continuity plan.

Also, in a case in which a business continuity plan is made with important work overevaluated or underevaluated due to an error or the like in the analysis and the evaluation of the effects on the business and the risks, there is a concern that a desirable measure for preventing an incident and a measure for handling occurrence of an incident will not be made, and as a result, prevention of the incident and handling of occurrence of the incident will not be effectively performed.

The present invention was made in view of the aforementioned circumstances, and an object thereof is to efficiently analyze and precisely evaluate effects on a business and risks and to effectively make a measure for preventing an incident and a measure for handling occurrence of an incident.

### Means for Solving the Problem

In order to solve the aforementioned problem and achieve the object, an estimation method according to the present invention is an estimation method executed by an estimation apparatus, in which the estimation apparatus includes a storage unit that stores a correspondence between businesses and work processes configuring the businesses, a correspondence between the work processes and work procedures configuring the work processes, a correspondence among the work procedures, work assist systems used in the work procedures, and work functions of each of the work assist systems, and a correspondence among the work assist systems and work functions configuring the work assist systems, programs configuring each of the work functions, software used by each of the programs, and setting information of each piece of the software, the method including: deriving correspondences between the businesses and any one or a plurality of the work assist systems, the work functions, the programs, the software, and the setting information of the software with reference to the storage unit; calculating any one or a plurality of second importances of the work assist systems, the work functions, the programs, the software, and the setting information of the software that correspond to each other using predetermined first importances of the businesses; analyzing third importances based on utilization trends of any one or a plurality of the work assist systems, the work functions, the programs, the software, and the setting information of the software that correspond to each other using utilization trends of the work assist systems in a predetermined period of time and the calculated second importances; and computing effects on the businesses using failure information of the work assist systems, the calculated second importances, and the analyzed third importances based on the utilization trends.

### Effects of the Invention

According to the present invention, it is possible to efficiently analyze and precisely evaluate an effect on a business and a risk and to make an effective measure for preventing an incident and a measure for addressing occurrence of an incident.

### BRIEF DESCRIPTION OF DRAWINGS

FIG. 1 is a schematic diagram illustrating, as an example, an overview configuration of a system including an estimation apparatus according to the present embodiment.

FIG. 2 is a diagram for explaining an example of setting of importances and execution frequencies.

FIG. 3 is an explanatory diagram for explaining business related information.

FIG. 4 is an explanatory diagram for explaining work assist system related information.

FIG. 5 is an explanatory diagram for explaining work assist system related information.

FIG. 6 is a diagram illustrating an example of screen display for a computation result.

FIG. 7 is a diagram illustrating an example of screen display for a computation result.

FIG. 8 is a flowchart illustrating an estimation processing procedure.

FIG. 9 is a diagram illustrating an example of a computer that executes an estimation program.

### DESCRIPTION OF EMBODIMENTS

Hereinafter, an embodiment of the present invention will be described in detail with reference to the drawings. Note that the present invention is not limited by the embodiment. Also, the same reference signs are applied to illustrate the same parts in illustration of the drawings.

System Configuration

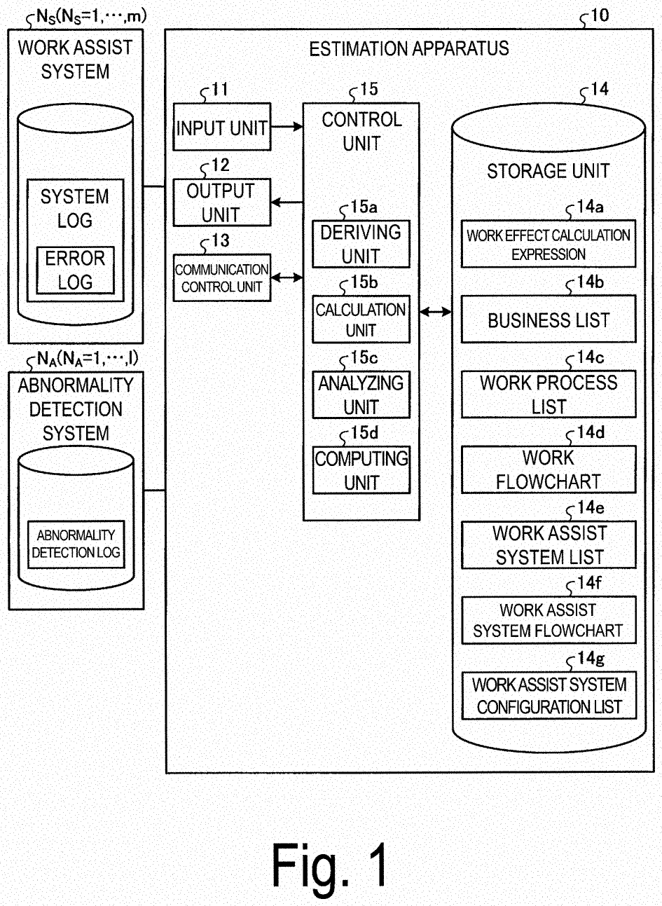

FIG. 1 is a schematic view illustrating, as an example, an overview configuration of a system including an estimation apparatus according to the present embodiment. As illustrated as an example in FIG. 1, an estimation apparatus 10 according to the present embodiment performs estimation processing, which will be described later, using information regarding a plurality of work assist systems Ns (Ns=1, m) and a plurality of abnormality detection systems NA (NA=1, . . . 1).

The work assist systems Ns are IT systems that are used by an organization that conducts a business to execute work. Each work assist system Ns stores system logs and error logs. The system logs are operation history of the corresponding work assist system Ns. In the estimation processing, which will be described later, a utilization trend of the corresponding work assist system Ns is analyzed using the system logs. System logs also include error logs. The error logs include failure information indicating which of the work functions of the corresponding work assist system Ns, programs, software, or setting information of the software an abnormal state corresponds to in a case in which an abnormality has occurred. In the estimation processing, which will be described later, system logs including the failure information may be used instead of the error logs.

The abnormality detection system NA is a system for detecting an abnormality in the work assist system Ns. One or more abnormality detection systems NA are present to correspond to each of or a plurality of work assist systems Ns. Each abnormality detection system NA stores abnormality detection logs that are histories in cases in which abnormalities in its target work assist systems Ns are detected. The abnormality detection logs include failure information indicating which of work functions of the target work assist systems Ns, programs, software, and setting information of the software the abnormal states correspond to.

Configuration of Estimation Apparatus

As illustrated as an example in FIG. 1, the estimation apparatus 10 is realized with a general-purpose computer such as a personal computer and includes an input unit 11, an output unit 12, a communication control unit 13, a storage unit 14, and a control unit 15.

The input unit 11 is realized using an input device such as a keyboard or a mouse and inputs various kinds of instruction information for starting processing to the control unit 15 in response to an operation input by an operator. The output unit 12 is realized with a display device such as a liquid crystal display, a printing device such as a printer, or the like. For example, the output unit 12 displays a result of estimation processing, which will be described below.

The communication control unit 13 is realized with a network interface card (NIC) or the like and controls communication between an external device and the control unit 15 via an electric communication line such as a local area network (LAN) or the Internet. For example, the communication control unit 13 controls communication among the work assist systems Ns, the abnormality detection systems NA, or a management device that manages various kinds of information related to a business, work, work assist systems Ns, and the like used in the estimation processing, which will be described later, and the control unit 15.

The storage unit 14 is realized with a semiconductor memory device such as a random access memory (RAM) or a flash memory or a storage device such as a hard disk or an optical disc. Note that the storage unit 14 may be configured to communicate with the control unit 15 via the communication control unit 13.

In the present embodiment, the storage unit 14 stores a work effect calculation expression 14a, a business list 14b, a work process list 14c, a work flowchart 14d, a work assist system list 14e, a work assist system flowchart 14f, a work assist system configuration list 14g, and the like. Such information is collected from the management device that manages various kinds of information related to the business, the work, the work assist systems Ns, and the like prior to the estimation processing, which will be described later, and is stored in the storage unit 14. Note that such various kinds of information may be collected not only in a case in which the information is stored in the storage unit 14 of the estimation apparatus 10 but also in a case in which the estimation processing described later is executed, for example.

The work effect calculation expression 14a includes predetermined relational expressions that define relations of various kinds of information used in the estimation processing, which will be described later. The relational expressions define functions to be applied and coefficients of the functions.

The business list 14b is a list of businesses that are targets of the estimation processing, which will be described later. The business list 14b includes an importance set for each of the businesses on the basis of a business scale, a management policy, and the like. The importance may be expressed with a discrete value of high, middle, and low or may be expressed with a successive value such as a sales amount realized by each of the businesses.

Moreover, the business list 14b includes a classification of an execution frequency of each business indicating which of routine work that is repeatedly executed many times in each business and non-routine work that is executed only once or only a limited number of times such as a project. Also, the business list 14b includes predetermined values of the numbers of executions and of execution frequencies in arbitrary periods of time for the routine work and includes predetermined values of the numbers of executions for the non-routine work.

The work process list 14c is information indicating correspondences between businesses and work processes configuring the businesses. Specifically, the work process list 14c is information indicating correspondences of the businesses and work process groups configuring each of the businesses and order relations of the work processes configuring each of the work process groups. The work process list 14c includes classifications indicating which of routine work and non-routine work an execution frequency of each work process group or each work process corresponds to. Also, the work process list 14c includes predetermined values of the numbers of executions and of execution frequencies in arbitrary periods for the routine work and predetermined values of the numbers of executions for the non-routine work.

Note that an importance of each work process group or each work process set on the basis of a business scale, a management policy, and the like may be included. The importance may be expressed with a discrete value of high, middle, or low or may be expressed with a successive value such as a sales amount realized by each work process group or each work process.

The work flowchart 14d is information indicating correspondences between work processes and work procedures configuring the work processes. Specifically, the work flowchart 14d is information indicating correspondences between work processes and work procedure groups configuring the work processes and order relations of the work procedures configuring each work procedure group. The work flowchart 14d includes classifications indicating which of routine work or non-routine work an execution frequency of each work procedure group or each work procedure corresponds to. Also, the work flowchart 14d includes predetermined values of the numbers of executions and of execution frequencies in arbitrary periods for the routine work and predetermined values of the numbers of executions for the non-routine work.

Note that an importance set for each work procedure group or each work procedure on the basis of a business scale, a management policy, and the like may be included. The importance may be expressed with a discrete value of high, middle, or low or may be expressed with a successive value such as a sales amount realized by each work procedure group or each work procedure.

Classifications indicating which of routine work or non-routine work an execution frequency corresponds to and predetermined values of the numbers of executions and of the execution frequencies may be included only for some of the businesses in the aforementioned business list 14b, the work process groups or the work processes in the work process list 14c, and the work procedure groups or the work procedures in the work flowchart 14d.

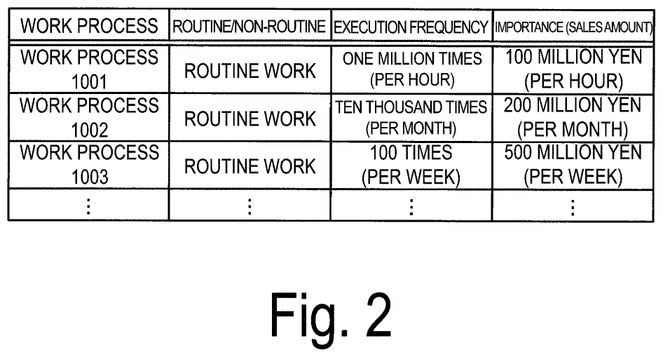

Here, FIG. 2 is a diagram illustrating an example of setting of importances and execution frequencies. In FIG. 2, an example of setting of importances and execution frequencies for work processes is illustrated. FIG. 2 illustrates, as an execution frequency of a work process 1001, that the work process is routine work and the execution frequency thereof is one million times per hour, and as an importance thereof, that the sales amount per hour is 100 million yen, for example.

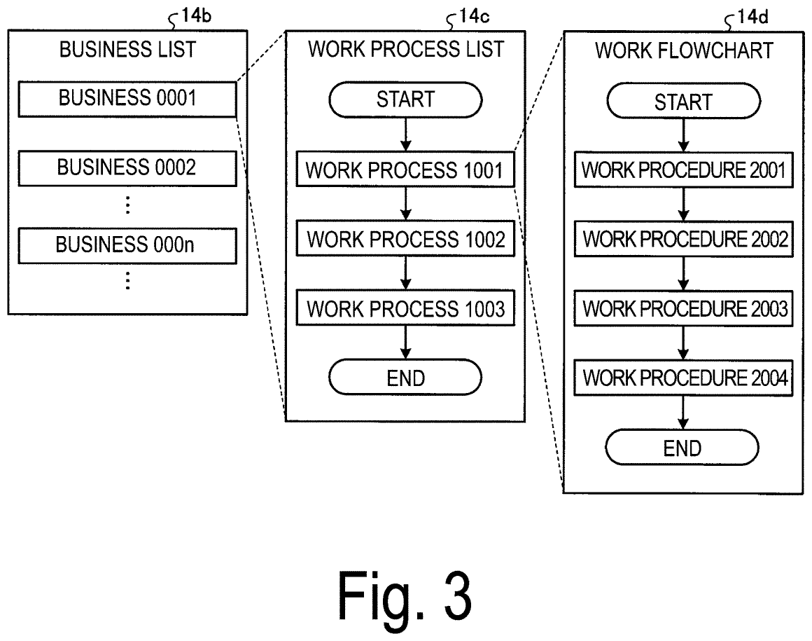

Also, FIG. 3 is an explanatory diagram for explaining business related information. The business related information is the business list 14b, the work process list 14c, and the work flowchart 14d described above. As illustrated in FIG. 3, the control unit 15, which will be described later, can associate the businesses, the work process groups, the work processes, the work procedure groups, and the work procedures using such business related information.

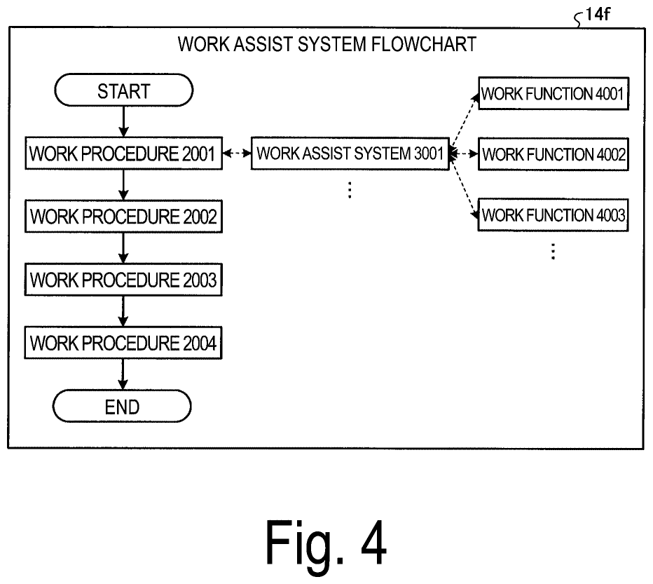

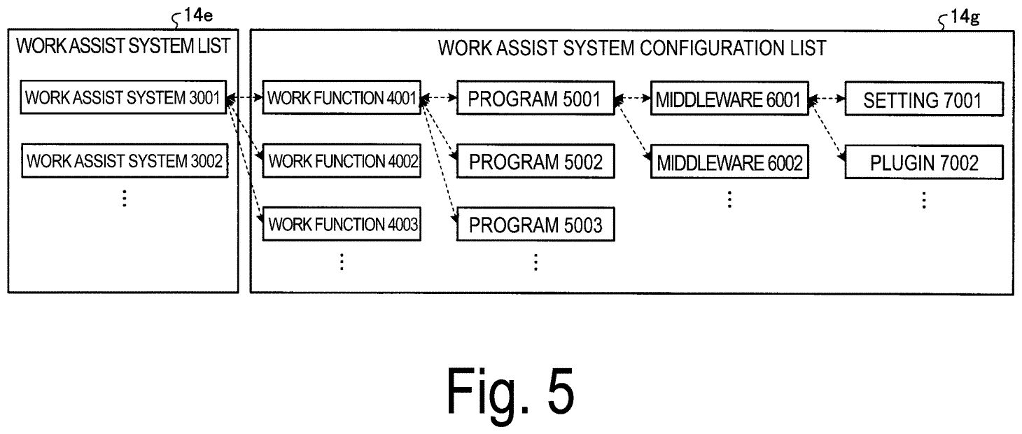

Also, FIGS. 4 and 5 are explanatory diagrams for explaining work assist system related information. The work assist system related information is a work assist system list 14e, a work assist system flowchart 14f, and a work assist system configuration list 14g.

The work assist system list 14e is information indicating work assist systems used for works. Specifically, the work assist system list 14e is information indicating a list of work assist systems used in each work procedure.

The work assist system flowchart 14f is information indicating correspondences among work procedures, work assist systems used in the work procedures, and work functions of each work assist systems. Specifically, the work assist system flowchart 14f is information indicating a list of correspondences among work procedures, work assist systems used in each work procedure, and work functions of each work assist system.

FIG. 4 illustrates, as an example, a data configuration of the work assist system flowchart 14f. As illustrated in FIG. 4, the work assist system flowchart 14f is information associating work functions in the aforementioned work flowchart 14d with the work assist systems and work functions of each of the work assist systems.

Also, the work assist system configuration list 14g is information indicating correspondences among the work assist systems, work functions configuring the work assist systems, programs configuring each of the work functions, software used by each of the programs, and setting information of each piece of the software. Specifically, the work assist system configuration list 14g includes correspondences among the work assist systems, the work functions configuring each of the work assist systems, programs configuring each of the work functions, OSs used by each of the programs, middleware, and software such as applications. Also, the work assist system configuration list 14g includes correspondences of software, setting of each piece of the software, and setting information of setting values such as codes, modules, and plugins. Here, the software setting information also includes functions called by programs, such as functions called by a certain program of Java (registered trademark), for example.

FIG. 5 illustrates, as an example, a relation between the work assist system list 14e and the work assist system configuration list 14g. As illustrated in FIG. 5, the control unit 15 can associate the work assist systems, the work functions, the programs, the software, and the software setting information using the work assist system list 14e and the work assist system configuration list 14g.

Thus, the control unit 15 can associate the work procedures, the work assist systems used in each of the work procedures, the work functions, the programs, the software, and the software setting information using the work assist system related information, that is, the work assist system list 14e, the work assist system flowchart 14f, and the work assist system configuration list 14g as illustrated in FIGS. 4 and 5.

Also, a uniquely identifiable element name or element ID is defined for each element in the business list 14b, the work process list 14c, the work flowchart 14d, the work assist system list 14e, the work assist system list 14e, the work assist system flowchart 14f, and the work assist system configuration list 14g described above.

In this manner, the control unit 15 can associate the elements of the businesses, the work processes, the work procedures, the work assist systems, the work functions, the programs, the software, and the software setting information as illustrated in FIGS. 3 to 5. The control unit 15 can thus identify elements in other lists or flowcharts related to elements in any of the lists or the flowcharts across these lists or the flowcharts. For example, the control unit 15 can identify all businesses using a certain work function.

FIG. 1 will be described again. The control unit 15 is realized using a central processing unit (CPU) and executes a processing program stored in a memory. In this manner, the control unit 15 functions as a deriving unit 15a, a calculation unit 15b, an analyzing unit 15c, and a computing unit 15d as illustrated as an example in FIG. 1. Note that each of or some of these functional units may be implemented by different pieces of hardware.

The deriving unit 15a derives correspondences between a business and any one or a plurality of the work assist systems, the work functions, the programs, the software, and the software setting information with reference to the storage unit 14. In other words, the deriving unit 15a mutually associates the elements of the businesses, the work processes, the work procedures, the work assist systems, the work functions, the programs, the software, or the software setting information as illustrated in FIGS. 3 to 5. Note that it is assumed that the work effect calculation expression 14a includes predetermined relational expressions for mutually associating these elements. Also, the present embodiment is not limited to a case in which all of the work assist systems, the work functions, the programs, the software, and the software setting information are associated with the businesses and also includes a case in which some of them are associated with the businesses.

Note that the present embodiment is not limited to the case in which various kinds of information such as the work effect calculation expression 14a, the business list 14b, the work process list 14c, the work flowchart 14d, the work assist system list 14e, the work assist system flowchart 14f, and the work assist system configuration list 14g is stored in the storage unit 14 as described above. For example, the control unit 15 may include a collecting unit that collects such information prior to the processing performed by the deriving unit 15a.

The calculation unit 15b calculates any one or a plurality of importances of the work assist systems, the work functions, the programs, the software, and the software setting information that correspond to each other, using predetermined importances of the businesses. Specifically, the calculation unit 15b acquires an importance of a business that is a target of estimation processing from the business list 14b and substitutes the importance into a predetermined relational expression in the work effect calculation expression 14a. In this manner, the calculation unit 15b calculates importances of the work assist systems, the work functions, the programs, the software, or the software setting information that correspond to each other and that are associated by the deriving unit 15a.

The predetermined relational expression used here may be a relational expression that defines functions or coefficients of the functions to calculate each of the importances of the work assist systems, the work functions, the programs, the software, or the software setting information with predetermined weighting. Each importance calculated here can be defined as a static importance calculated from a predetermined value.

The calculation unit 15b may further calculate each importance using a predetermined execution frequency of a business. Here, the execution frequency of a business is the number of executions and the execution frequency of the business. The calculation unit 15b calculates each importance using the execution frequency or the number of executions set in the business list 14b in addition to the importance of the business. In this case, the calculation unit 15b acquires the importance and the execution frequency of the business from the business list 14b and substitutes the importance and the execution frequency into the predetermined relational expression in the work effect calculation expression 14a.

In this case, the calculation unit 15b calculates each importance using the predetermined relational expression in the work effect calculation expression 14a defined using the importance and the execution frequency of the business. The predetermined relational expression used here may be a relational expression that defines functions or coefficients of the functions so as to calculate each of the importances of the work assist systems, the work functions, the programs, the software, or the software setting information with predetermined weighting. Each importance calculated here can be defined as a static importance based on the predetermined execution frequency, namely, the utilization frequency of each work assist system.

The calculation unit 15b may further calculate each importance using a predetermined importance of each work process or work procedure. Also, the calculation unit 15b may further calculate each importance using a predetermined execution frequency of each work process or work procedure.

In this case, the calculation unit 15b further calculates each importance using the importance, the execution frequency, or the number of executions of a work process group or a work process acquired from the work process list 14c and the importance, the execution frequency, or the number of executions of a work procedure group or a work procedure acquired from the work flowchart 14d. In this case, the calculation unit 15b calculates each importance using the predetermined relational expression in the work effect calculation expression 14a defined using the importance and the execution frequency of a business, a work process group or a work process, or a work procedure group or a work procedure.

Note that the predetermined relational expression used here may be defined such that some of importances of the work process groups or the work processes, or the work procedure groups or the work procedure are used. Also, the predetermined relational expression used here may be defined such that some of the execution frequencies of the business, the work process groups or the work processes, or the work procedure groups or the work procedures are used. In that case, it is assumed that an importance value of the work process group or the work process, or the work procedure group or the work procedure used for the predetermined relational expression is set in the work process list 14c or the work flowchart 14d. Also, it is assumed that a value of execution frequency of a business, a work process group or a work process, or a work procedure group or a work procedure used in the predetermined relational expression is set in the business list 14b, the work process list 14c, or the work flowchart 14d.

Specifically, the calculation unit 15b calculates a set of values of (an importance, an execution frequency, and the number of executions) as an importance of each of the work assist systems, the work functions, the programs, the software, or the software setting information. Here, the set of a plurality of values of (the importance, the execution frequency, and the number of executions) calculated based on a plurality of businesses, work processes, or work procedures is associated with each of the work assist systems, the work functions, the programs, the software, and the software setting information. Thus, it is assumed that each of importances of the work assist systems, the work functions, the programs, the software, or the software setting information is represented by absolute evaluation, relative evaluation, or a combination of absolute evaluation and relative evaluation of the set of the plurality of values (the importance, the execution frequency, and the number of executions) calculated on the basis of each of the plurality of businesses, the work processes, or the work procedures.

The functions or the coefficients of the functions of the predetermined relational expression used by the calculation unit 15b may be defined such that all the importances of the work assist systems, the work functions, the programs, the software, or the software setting information related to businesses with high importances are high, for example. Alternatively, the functions or the coefficients of the functions of the predetermined relational expression may be defined such that each of the importances of the work assist systems, the work functions, the programs, the software, or the software setting information is calculated based on the numbers of related business, work processes, and work procedures.

Also, the calculation unit 15b may calculate each of the importances of the work assist systems, the work functions, the programs, the software, and the software setting information that correspond to each other for each of the lists and the flowcharts of the work assist systems, the work functions, the programs, the software, or the software setting information. Alternatively, the calculation unit 15b may calculate each of the importances across a plurality of lists and flowcharts.

The analyzing unit 15c analyzes importances based on utilization trends of any one or a plurality of the work assist systems, the work functions, the programs, the software, and the software setting information that correspond to each other, using utilization trends of the work assist systems Ns in a predetermined period of time and the calculated importances. Here, dynamic importances are calculated through analysis on the basis of the utilization trends of the work systems.

Here, the utilization trends of the work assist systems Ns are analyzed using system logs of the work assist systems Ns. The analyzing unit 15c acquires system logs of the work assist systems Ns in a predetermined period of time via the communication control unit 13 and analyzes utilization trends of each of the work functions of the work assist systems Ns.

Here, ranges of the work assist systems Ns and the work functions that are targets of the analysis are not particularly limited, and all the work functions of all the work assist systems may be the targets, or some may be the targets. Also, the predetermined period of time that is a target of the analysis is not particularly limited and may be the past year, the past month, or both periods, for example.

The analyzing unit 15c analyzes utilization trends, such as a trend in which a specific amount of utilization is constantly observed, a trend in which utilization periodically varies, and a trend in which utilization is observed only in a specific period of time, for example. The analyzing unit 15c displays, as results of the analysis, features of the utilization trends in the form of a graph, a table, or the like of chronological utilization histories, for example, on the output unit 12.

The analyzing unit 15c associates the analysis results of the utilization trends of the work assist systems Ns and the work functions with the work assist systems, the work functions, the programs, the software, or the software setting information that correspond to each other associated by the deriving unit 15a, using a predetermined relational expression, for example.

Also, the analyzing unit 15c substitutes the analysis results of the utilization trends associated with the work assist systems, the work functions, the programs, the software, or the software setting information and each of the importances calculated by the calculation unit 15b into a predetermined relational expression and calculates importances based on the utilization trends. With the predetermined relational expression of the work effect calculation expression 14a used here, each of the importances is calculated using ratios between the analysis results of the utilization trends of each of the work functions, the programs, the software, and the software setting information and each of the utilization frequencies (execution frequencies or the numbers of executions) calculated by the calculation unit 15b, for example. Note that the functions and the coefficients of the functions of the predetermined relational expression used here are arbitrarily defined.

For example, it is assumed that, according to the business continuity plan, the work function 4001 that is used in the work process 1001 that is one of components of the business 0001 has been estimated to be used one million times per hour only for the work process 1001, and the sales amount (importance) has been estimated to be 100 million yen. On the other hand, it may be calculated that the work function 4001 is used 1.5 million times per hour and the sales amount (importance) of 150 million yen has been realized, through analysis of the utilization trend (utilization record) performed by the analyzing unit 15c in the present embodiment.

The computing unit 15d uses failure information of the work assist systems Ns, each of the calculated importances, and each of the importances based on the analyzed utilization trends to compute effects on the businesses. Specifically, the computing unit 15d acquires the failure information of the work assist systems Ns from the work assist systems Ns or the abnormality detection systems NA via the communication control unit 13 first.

For example, the computing unit 15d acquires the failure information of the work assist systems Ns in a case in which error logs have occurred in the work assist systems Ns, in a case in which the abnormality detection systems NA detect abnormalities in the work assist systems Ns, or the like when an incident occurs. Note that the computing unit 15d may periodically acquire failure information of the work assist systems Ns. Alternatively, the computing unit 15d may acquire the failure information of the work assist systems Ns manually input via the input unit 11 when an incident occurs.

Next, the computing unit 15d substitutes acquired failure information and static importances calculated by the calculation unit 15b, that is, static importances based on the utilization frequencies in the business continuity plan, into the predetermined relational expression of the work effect calculation expression 14a and computes effects of failure locations on the businesses such as importances of the failure locations. Here, the functions and the coefficients of the functions in the predetermined relational expression used by the computing unit 15d are arbitrarily defined.

Also, the computing unit 15d substitutes the acquired failure information and the importances analyzed by the analyzing unit 15c, that is, dynamic importances based on the utilization trends of the work assist systems, into the predetermined relational expression of the work effect calculation expression 14a and computes the effects of the failure locations on the businesses. Here, the functions and the coefficients of the functions of the predetermined relational expression used by the computing unit 15d are also arbitrarily defined.

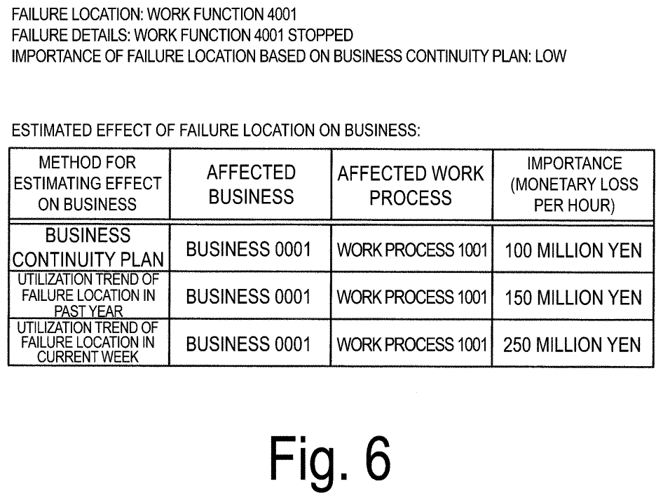

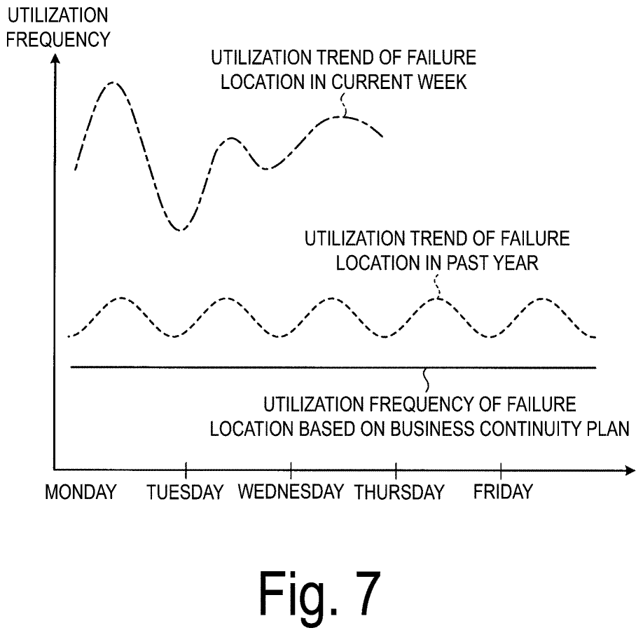

In addition, the computing unit 15d outputs the computation results in the form of a graph or the like to the output unit 12. Here, FIGS. 6 and 7 are diagrams illustrating an example of screen display of the computation results. As illustrated in FIG. 6, the computing unit 15d outputs a failure location and failure details as risks that have occurred, for example. Also, the computing unit 15d outputs the computation results and reference information representing effects on the businesses, for example, as effects on the businesses that have occurred to the output unit 12.

In the example illustrated in FIG. 6, a failure location “work function 4001” and failure details “work function 4001 stopped” are displayed as a risk that has occurred. Also, in FIG. 6, an importance “low” of the failure location based on (utilization frequency in) the business continuity plan and an importance of the failure location based on the utilization trend of the work assist system in predetermined periods of time (the past year and the current week) are displayed as calculation results.

In other words, FIG. 6 illustrates that an importance (monetary loss per hour) of the work process “work process 1001” affected by a failure in the business “business 0001” affected by the failure in terms of the business continuity plan is “100 million yen,” for example. Also, the fact that an importance (monetary loss per hour) of the work process “work process 1001” affected by the failure in the business “business 0001” affected in terms of a utilization trend of a failure location in the past year is “150 million yen” is illustrated. Also, the fact that an importance (monetary loss per hour) of the work process “work process 1001” affected by the failure in the business “business 0001” affected in terms of a utilization trend of the failure location for the current week is “250 million yen” is illustrated.

In addition, FIG. 7 illustrates, as an example, the utilization frequency of the failure location based on the business continuity plan and the utilization trends of the failure location in predetermined periods of time (the past year and the current week) as reference information representing effects on the business. As illustrated in FIG. 7, in a case in which the utilization frequency of the failure location based on the business continuity plan and the utilization trend of the failure location based on utilization records of the work assist systems Ns are different from each other, there is a probability that the measure for addressing the failure scheduled by the business continuity plan is excessive or insufficient and is not appropriate. In that case, the user can examine a more effective measure than the standard measure scheduled by the business continuity plan with reference to the computation result illustrated in FIG. 6.

Alternatively, in a case in which the number of utilizations in the utilization trend of the failure location in the past year is larger than the utilization frequency of the failure location based on the business continuity plan while the number of utilizations in the utilization trend of the failure location in the past month is equivalent, for example, the user can appropriately select the measure scheduled by the business continuity plan.

In this manner, the user can appropriately select which of the standard measure or the exceptional measure among the measures scheduled by the business continuity plan is to be employed, with reference to the computation result of the computing unit 15d.

Estimation Processing

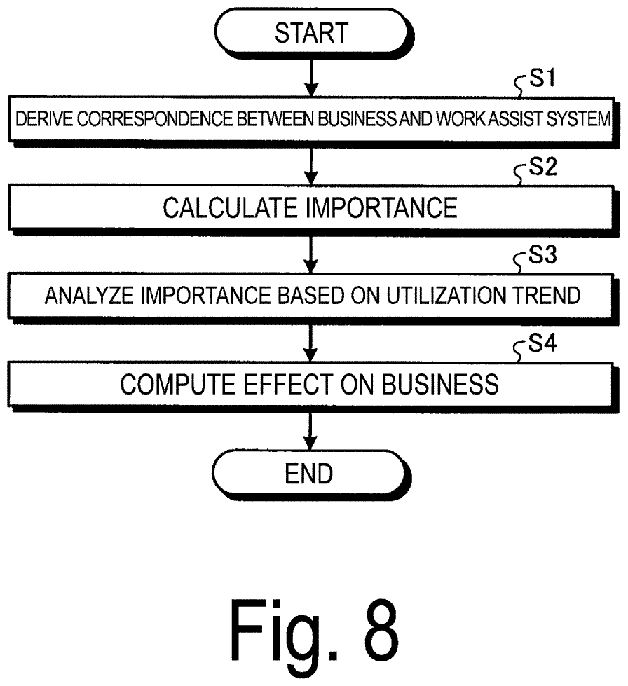

Next, the estimation processing performed by the estimation apparatus 10 according to the present embodiment will be described with reference to FIG. 8. FIG. 8 is a flowchart illustrating an estimation processing procedure. The flowchart of FIG. 8 starts at a timing at which a user inputs an operation to provide an instruction for the start, for example.

First, the deriving unit 15a derives mutual correspondences of businesses, work processes, work procedures, work assist systems, work functions, programs, software, or software setting information as correspondences between businesses and work assist systems with reference to the storage unit 14 (Step S1).

The calculation unit 15b calculates importances of the work assist systems, the work functions, the programs, the software, or the software setting information that correspond to each other using predetermined importances of the businesses (Step S2).

The analyzing unit 15c analyzes importances based on utilization trends of the work assist systems, the work functions, the programs, the software, or the software setting information that correspond to each other using utilization trends of the work assist systems Ns in a predetermined period of time and each of the calculated importances (Step S3).

The computing unit 15d computes effects on the businesses using failure information of the work assist systems Ns, each of the calculated importances, and each of the importances based on the analyzed utilization trends (Step S4). Also, the computing unit 15d outputs the computation result to the output unit 12 and displays the computation result thereon in the form of a graph or the like. In this manner, the series of estimation processes ends.

Note that each of the aforementioned steps may be successively executed at the time of occurrence of an incident or may be executed separately in different time zones. For example, Steps S1 to S3 may be executed at arbitrary timings in a normal state while Step S4 may be executed at the time of occurrence of an incident and the like. In that case, it is only necessary for the estimation apparatus 10 to store the results in Steps S1 to S3 in the storage unit 14 and read the results from the storage unit 14 at the time of the execution of Step S4.

Further, the aforementioned estimation processing performed by the estimation apparatus 10 may be executed to examine a measure for handling occurrence of an incident or may be executed to make or amend a business continuity plan.

In the estimation apparatus 10 according to the present embodiment, the deriving unit 15a derives correspondences of the businesses and any one or a plurality of the work assist systems, the work functions, the programs, the software, and the software setting information with reference to the storage unit 14 as described above. The calculation unit 15b calculates importances of any one or a plurality of the work assist systems, the work functions, the programs, the software, and the software setting information that correspond to each other, using the predetermined importances of the businesses. The analyzing unit 15c analyzes importances based on utilization trends of any one or a plurality of the work assist systems, the work functions, the programs, the software, and the software setting information that correspond to each other, using the utilization trends of the work assist systems in a predetermined period of time and each of the calculated importances. The computing unit 15d computes effects on the businesses using failure information of the work assist systems Ns, each of the calculated importances, and each of the importances based on the analyzed utilization trends.

In this manner, the estimation apparatus 10 can efficiently analyze and evaluate effects on the businesses and risks on the basis of the latest information regarding business structures, the work processes, and the utilization trends of the work assist systems Ns. For example, it is possible to perform risk analysis in an ordinary state using static importances calculated by the calculation unit 15b. Further, it is possible to perform risk analysis at the time of occurrence of a failure using dynamic importances based on utilization trends of the work systems, which are calculated by the analyzing unit 15c. Therefore, it is possible to appropriately select which of a standard measure scheduled by the business continuity plan or an exceptional measure is to be employed at the time of an occurrence of an incident. In this manner, the estimation apparatus 10 can efficiently analyze and precisely evaluate the effects on the businesses and the risks and can effectively schedule a measure for preventing an incident and a measure for addressing occurrence of an incident.

Also, the calculation unit 15b may further calculate each of the importances using predetermined execution frequencies of the businesses. Also, the calculation unit 15b may further calculate each of the importances using predetermined importances of the work processes or the work procedures. Also, the calculation unit 15b may further calculate each importance using a predetermined execution frequency of each work process or work procedure. In this manner, the estimation apparatus 10 can more precisely evaluate the effects on the businesses and the risks.

Program

It is also possible to create a program in which processing executed by the estimation apparatus 10 according to the present embodiment described above is described in a computer-executable language. In one embodiment, the estimation apparatus 10 can be implemented by installing the estimation program that executes the aforementioned estimation processing as package software or online software on a desired computer. For example, it is possible to cause an information processing apparatus to function as the estimation apparatus 10 by causing the information processing apparatus to execute the aforementioned estimation program. The information processing apparatus described here includes a desktop or notebook personal computer. In addition, mobile communication terminals such as a smartphone, a mobile phone, and a personal handyphone system and further slate terminals such as a personal digital assistant (PDA) are included in the scope of the information processing apparatus. Also, the functions of the estimation apparatus 10 may be mounted in a cloud server.

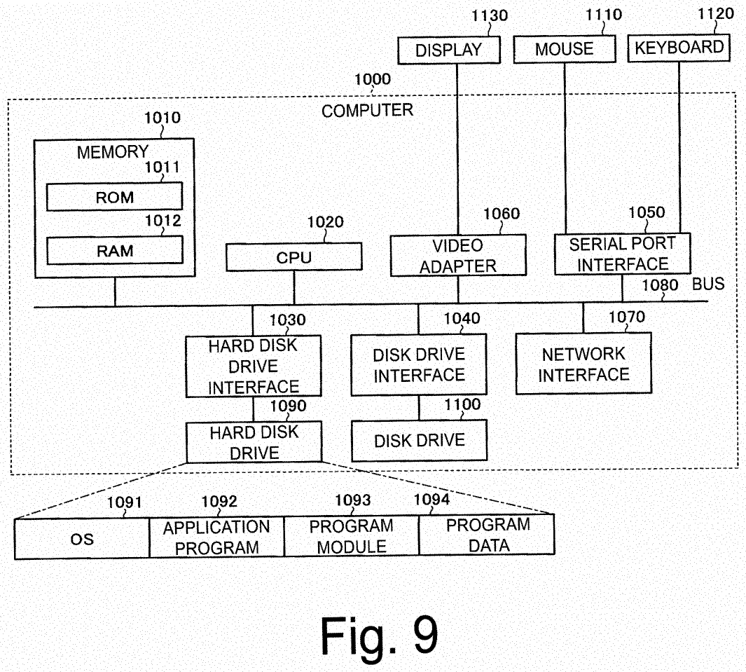

FIG. 9 is a diagram illustrating an example of a computer that executes the estimation program. A computer 1000 includes, for example, a memory 1010, a CPU 1020, a hard disk drive interface 1030, a disk drive interface 1040, a serial port interface 1050, a video adapter 1060, and a network interface 1070. These units are connected via a bus 1080.

The memory 1010 includes a read only memory (ROM) 1011 and a RAM 1012. The ROM 1011 stores, for example, a boot program such as a basic input output system (BIOS). The hard disk drive interface 1030 is connected to a hard disk drive 1090. The disk drive interface 1040 is connected to a disk drive 1100. A removable storage medium such as a magnetic disk or an optical disc, for example, is inserted into the disk drive 1100. A mouse 1110 and a keyboard 1120, for example, are connected to the serial port interface 1050. A display 1130, for example, is connected to the video adapter 1060.

Here, the hard disk drive 1090 stores, for example, an OS 1091, an application program 1092, a program module 1093, and program data 1094. Each piece of the information described in the aforementioned embodiment is stored in, for example, the hard disk drive 1090 and the memory 1010.

Further, the estimation program is stored in the hard disk drive 1090 as the program module 1093 in which instructions to be executed by the computer 1000 are described, for example. Specifically, the program module 1093 in which processing executed by the estimation apparatus 10 described in the aforementioned embodiment is described is stored in the hard disk drive 1090.

Also, data to be used in information processing according to the estimation program is stored as the program data 1094 in the hard disk drive 1090, for example. The CPU 1020 loads the program module 1093 and the program data 1094 stored in the hard disk drive 1090 onto the RAM 1012 as needed and executes each of the aforementioned procedures.

Note that the program module 1093 and the program data 1094 related to the estimation program are not limited to the case in which they are stored in the hard disk drive 1090 and may be stored in a removable storage medium, for example, and may be read by the CPU 1020 via the disk drive 1100 or the like. Alternatively, the program module 1093 or the program data 1094 related to the estimation program may be stored in another computer connected via a network such as a LAN or a wide area network (WAN) and may be read by the CPU 1020 via the network interface 1070.

Although the embodiment to which the present invention made by the present inventors is applied has been described above, the present invention is not limited by the description and the drawings constituting a part of the disclosure of the present invention according to the present embodiment. In other words, all of other embodiments, examples, operation technologies, and the like made by those skilled in the art based on the present embodiment fall within the scope of the present invention.

### REFERENCE SIGNS LIST

10 Estimation apparatus
11 Input unit
12 Output unit
13 Communication control unit
14 Storage unit
14a Work effect calculation expression
14b Business list
14c Work process list
14d Work flowchart
14e Work assist system list
14f Work assist system flowchart
14g Work assist system configuration list
15 Control unit
15a Deriving unit
15b Calculation unit
15c Analyzing unit
15d Computing unit

1. An estimation method to be performed by an estimation apparatus which includes a memory that stores a correspondence between businesses and work processes configuring the businesses, a correspondence between the work processes and work procedures configuring the work processes, a correspondence among the work procedures, work assist systems used in the work procedures, and work functions of each of the work assist systems, and a correspondence among the work assist systems and work functions configuring the work assist systems, programs configuring each of the work functions, software used by each of the programs, and setting information of each piece of the software,
the method comprising:
deriving correspondences between the businesses and any one or a plurality of the work assist systems, the work functions, the programs, the software, and the setting information of the software with reference to the memory;
calculating any one or a plurality of second importances of the work assist systems, the work functions, the programs, the software, and the setting information of the software that correspond to each other using predetermined first importances of the businesses;
analyzing third importances based on utilization trends of any one or a plurality of the work assist systems, the work functions, the programs, the software, and the setting information of the software that correspond to each other using utilization trends of the work assist systems in a predetermined period of time and the calculated second importances; and
computing effects on the businesses using failure information of the work assist systems, the calculated second importances, and the analyzed third importances based on the utilization trends.

2. The estimation method according to claim 1, wherein the calculating of the second importances further includes calculating the second importances using predetermined frequencies of the businesses.

3. The estimation method according to claim 1, wherein the calculating of the second importances further includes calculation the second importances using predetermined fourth importances of the work processes or the work procedures.

4. The estimation method according to claim 1, wherein the calculating of the second importances further includes calculating the second importances using predetermined execution frequencies of the work processes or the work procedures.

5. An estimation apparatus comprising:
a memory that stores a correspondence between businesses and work processes configuring the businesses, a correspondence between the work processes and work procedures configuring the work processes, a correspondence among the work procedures, work assist systems used in the work procedures, and work functions of each of the work assist systems, and a correspondence among the work assist systems and work functions configuring the work assist systems, programs configuring each of the work functions, software used by each of the programs, and setting information of each piece of the software;
deriving circuitry that derives correspondences between the businesses and any one or a plurality of the work assist systems, the work functions, the programs, the software, and the setting information of the software with reference to the memory;
calculation circuitry that calculate any one or a plurality of second importances of the work assist systems, the work functions, the programs, the software, and the setting information of the software that correspond to each other using predetermined first importances of the businesses;
analyzing circuitry that analyzes third importances based on utilization trends of any one or a plurality of the work assist systems, the work functions, the programs, the software, and the setting information of the software that correspond to each other using utilization trends of the work assist systems in a predetermined period of time and the calculated second importances; and
computing circuitry that computes effects on the businesses using failure information of the work assist systems, the calculated second importances, and the analyzed third importances based on the utilization trends.

6. A non-transitory computer readable medium including computer instructions which when executed cause a computer to perform:
deriving correspondences between businesses and any one or a plurality of work assist systems, work functions, programs, software, and setting information of the software with reference to a memory that stores a correspondence between the businesses and work processes configuring the businesses, a correspondence between the work processes and work procedures configuring the work processes, a correspondence among the work procedures, work assist systems used in the work procedures, and work functions of each of the work assist systems, and a correspondence among the work assist systems and work functions configuring the work assist systems, programs configuring each of the work functions, software used by each of the programs, and setting information of each piece of the software;
calculating any one or a plurality of second importances of the work assist systems, the work functions, the programs, the software, and the setting information of the software that correspond to each other using predetermined first importances of the businesses;
analyzing third importances based on utilization trends of any one or a plurality of the work assist systems, the work functions, the programs, the software, and the setting information of the software that correspond to each other using utilization trends of the work assist systems in a predetermined period of time and the calculated second importances; and
computing effects on the businesses using failure information of the work assist systems, the calculated second importances, and the analyzed third importances based on the utilization trends.
